(19) United States
(12) Patent Application Publication
(10) Pub. No.: US 2002/0184213 A1
(43) Pub. Date: Dec. 5, 2002

(54) Data instance transformation tool for transforming a source instance to a target instance

(75) Inventors: Christina P. Lau, Scarborough (CA); David M. Lauzon, Etobicoke (CA); Craig Salter, Hamilton (CA)

Correspondence Address: Jeffrey S. LaBaw, International Business Machines, Intellectual Property Law, 11400 Burnet Rd., Austin, TX, 78758, US

(73) Assignee: INTERNATIONAL BUSINESS MACHINES CORPORATION, Armonk, NY

(21) Appl. No.: 10/132,342

(22) Filed: Apr. 25, 2002

(30) Foreign Application Priority Data
Jun. 1, 2001 (CA) 2,349,469

(51) Int. Cl. G06F 17/30

(52) U.S. Cl. 707/6

(57) ABSTRACT

Embodiments of the invention provide a graphical rendering of source and target data instances enabling a user to select mappings between elements in the source data instance and elements in the target data instance. The data instances are typically input to embodiments of the invention as text files (e.g., DTD, XML, XML Schema Definition (“XSD”) files, HTML files or the like), Additionally, in some embodiments additional characteristics or functions operating on data populating the mapped structures can be provided. Upon receipt of the mapping data (and, optionally, additional characteristic or function operations) embodiments of the invention generate a list of elements mapped from the target data instance. From this list, templates or code blocks are generated by embodiments of the invention which enable a script or source code file to be generated. The generated script or source code file, when processed on data streams of input data conforming to the original source data definition, will output a data stream which conforms to the original target data definition. The output data stream may be, for example, be formatted as an XML output file.

### FIELD OF THE INVENTION

The present invention relates to a data instance transformation tool and, more particularly, to a method, system, apparatus and related embodiments for transforming a source instance to a target instance.

### BACKGROUND OF THE INVENTION

Over the past several years the Internet, and specifically, the world wide web (WWW) portion of the Internet, has become almost ubiquitous in modern, high technology economies.

Initially, the WWW was used to enable people and organizations to provide useful information, such as product and service specifications, general information and multimedia (e.g., sound, full motion video, graphics, etc.), to interested parties. As a result, many consumers (whether consuming for personal or business reasons), when searching for a product, service or company, now use the WWW as their first source of information for products/services.

The information found on the WWW was provided to users on one or more web pages with a group of web pages provided by a single person or organization forming a web site. Web pages are provided to or downloaded by users and viewed by a web browser such as Netscape Navigator, Microsoft Internet Explorer or the like. An individual web page was created in a markup language known as the HyperText Markup Language (HTML) which is a subset of, or defined from, the Standard Generalized Markup Language (SGML).

HTML defines a document format in which with HTML tags, or codes, are embedded in the text. HTML defines the page layout, fonts and graphic elements as well as the hypertext links to other documents on the Web. Each link contains the URL, or address, of a Web page residing on the same server or any server worldwide, hence the name “World Wide” Web.

From these initial beginnings, the WWW has developed into a networked delivery system for the product and services previously only described. That is, the WWW (or a portion of it) has transformed into an electronic commerce (e-commerce) system. Accordingly, users/viewers of a page can select products and services to purchase. This often requires a user to input data (e.g., name, address, etc.) which, upon request, is transmitted to web page server. The operator of the web page can then use the information as desired.

As a result of these developments, the Internet, and the WWW, have become ubiquitous. This has led many organizations to begin transmitting data to various destinations (e.g., customers, suppliers, other parts of the organization) using the Internet. However, as is often the case with computer technology, data can be transmitted in various forms. Accordingly, and in order for the transmitters and receivers of this data to understand each other, another markup language—extensible Markup Language (XML), which is also defined from SGML—was developed.

XML is an open standard for describing data from the World Wide Web Consortium (W3C). It is used for defining data elements on a Web page and for business-to-business data transfers. It uses a tag structure similar to HTML. However, whereas HTML defines how elements are displayed, XML defines what those elements contain. HTML uses predefined tags, but XML allows tags to be defined or named by the developer of the page. Thus, virtually any type of data item, such as customer name, product identifier, items ordered, etc., can be identified. This identification allows Web pages to function like database records. By providing a common method for identifying data, XML provides supports for ease of data transfer—a particularly interesting area for business-to-business transactions which have, for years, taken part in electronic purchases/orders through proprietary electronic data interchange technologies.

However, communication difficulties have arisen due to the inherent flexibility in the naming of XML tags. Some of these difficulties have been due to different developers labeling the same data differently. For example, a first developer may tag data relating to a customer name as “customerName” while a second developer requires two pieces of data—“cust_FirstName” and “cust_LastName”—to identify the same information. To address this problem, standards have been proposed, such as cXML (for Commercial XML) from Ariba and CBL (Common Business Library) from Commerce One. These standards are proposed to operate as de facto XML vocabularies for business data. However, these standards have not been widely adopted. Moreover, while some of these proposed standards have been accepted to some degree, this partial acceptance has resulted in a fragmentation of the XML naming vocabulary which has resulted in the same problem; namely the labeling of the same data in a different manner.

Another solution proposed to address this naming difficulty, amongst others, was the extensible Stylesheet Language for Transformation (XLST). An XLST file can be written so that it can be used to transform a first or source data instance (e.g., XML) to a second or target data instance (e.g., XML, HTML, etc.). However, it has been realized that there is, to some degree, a lack of developers comfortable with XML and XLST. This problem becomes particularly apparent when complicated transformations are required.

In view of the foregoing it is desirable to provide a data instance transformation tool for transforming a source structure to a target structure which addresses, to some degree, the shortcomings identified above.

### SUMMARY OF THE INVENTION

The present invention is directed to a method, system and related embodiments which address, at least in part, the various described shortcomings.

Embodiments of the invention provide a graphical rendering of source and target data instances enabling a user to select mappings between elements in the source data instance and elements in the target data instance. Data is typically input to embodiments of the invention as text files (e.g., DTD, XML, XML Schema Definition (“XSD” ) files, HTML files or the like), Additionally, in some embodiments additional characteristics or functions operating on data populating the mapped instances can be provided. Upon receipt of the mapping data (and, optionally, additional characteristic or function operations) embodiments of the invention generate a list of elements mapped from the target data instance. From this list, templates or code blocks are generated by embodiments of the invention which enable a script or source code file to be generated. The generated script or source code file, when processed on data streams of input data conforming to the original source data definition, will output a data stream which conforms to the original target data definition. The output data stream may be, for example, be formatted as an XML output file.

In accordance with an aspect of the present invention there is provided method for transforming data conforming to a source data instance to data conforming to at least a portion of a target data instance, said method comprising: receiving mapping data, said mapping data mapping at least a portion of said source data instance to at least a portion of said target data instance; responsive to said mapping data received, generating a data instance transformation script whereby processing said script transforms data conforming to said source data instance to data conforming said target data instance; and wherein generating a data instance transformation script comprises: identifying each element in said target data instance; and for an element identified: generating an element transform script transforming data conforming to said source data instance to said element identified, wherein said element transform script corresponds to a portion of said mapping data.

In accordance with another aspect of the present invention there is provided computer readable medium storing data and instructions, said data and instructions, when processed by a computer system adapts said computer system to: receive mapping data, said mapping data mapping at least a portion of a source data instance to at least a portion of a target data instance; responsive to said mapping data received, generate a data instance transformation script whereby processing said script transforms data conforming to said source data instance to data conforming said target data instance; and wherein said data and instructions adapting said computer system to generate said data structure transformation script generated comprises data and instructions adapting said computer system to: identify each element in said target data structure; and for an element identified: generate an element transform script transforming data conforming to said source data structure to said element identified, wherein said element transform script corresponds to a portion of said mapping data.

In accordance with still another aspect of the present invention there is provided an apparatus for transforming data conforming to a source data instance to data conforming to at least a portion of a target data instance, said apparatus comprising: a means for mapping data, said mapping data mapping at least a portion of said source data instance to at least a portion of said target data instance; responsive to said mapping data received, a means for generating a data instance transformation script whereby processing said script transforms data conforming to said source data instance to data conforming said target data instance; and wherein said generating of said data instance transformation script generated comprises: a means for identifying each element in said target data instance; and for an element identified: a means for generating an element transform script transforming data conforming to said source data instance to said element identified, wherein said element transform script corresponds to a portion of said mapping data.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In the figures which illustrate an example embodiment of this invention:

FIG. 1 schematically illustrates a computer system embodying aspects of the invention;

FIG. 2 schematically illustrates, in greater detail, a portion of the computer system of FIG. 1;

FIG. 3 illustrates, in functional block form, a portion of FIG. 2;

FIG. 4B is an exemplary generated source file which is, optionally, provided to a user and used by the computer system of FIG. 1;

FIG. 4B is an exemplary input source file provided to and used by the computer system of FIG. 1;

FIG. 5 is an exemplary input target file provided to and used by the computer system of FIG. 1;

FIG. 6 is an exemplary display output by the computer system of FIG. 1;

FIG. 7 is an exemplary output file generated by the computer system of FIG. 1;

FIG. 8 is a flowchart of exemplary operations of the computer system of FIG. 1;

FIG. 9 is a flowchart detailing a portion of the operations illustrated in FIG. 8;

FIG. 10, is a flowchart detailing a portion of the operations illustrated in FIG. 9; and

FIG. 11 is a flowchart detailing a portion of the operations illustrated in FIG. 10.

### DETAILED DESCRIPTION

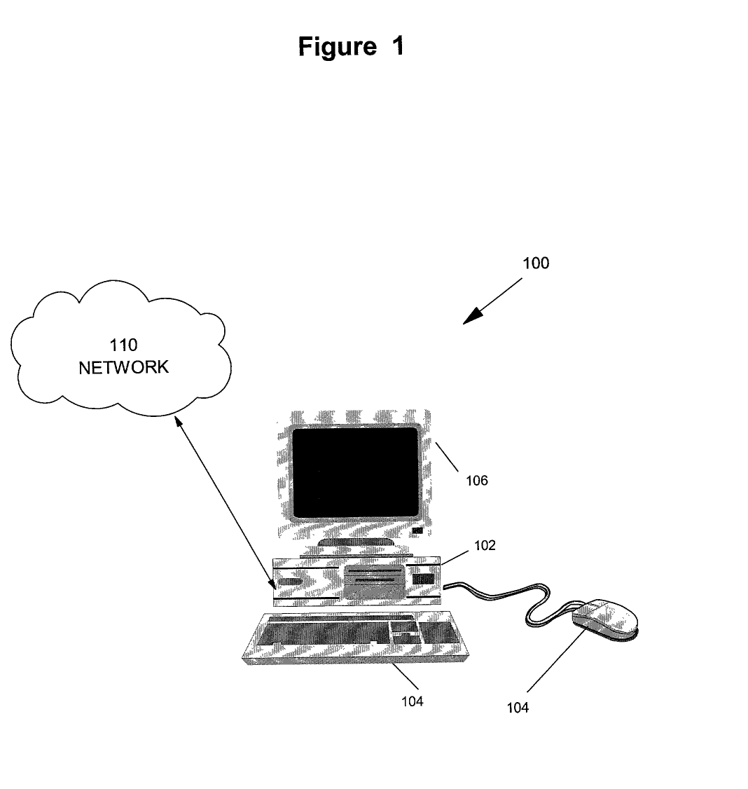

An embodiment of the invention, computer system 100, is illustrated in FIG. 1. Computer system 100, illustrated for exemplary purposes as a networked computing device, is in communication with other networked computing devices (not shown) via network 110. As will be appreciated by those of ordinary skill in the art, network 110 may be embodied using conventional networking technologies and may include one or more of the following: local area networks, wide area networks, intranets, public Internet and the like. Computer system 100 may, in some embodiments of the present invention, interact with other networked computer systems (not shown) to provide a distributed data instance transformation tool for transforming a source structure to a target structure.

Throughout the description herein, an embodiment of the invention is illustrated with aspects of the invention embodied solely on computer system 100. As will be appreciated by those of ordinary skill in the art, aspects of the invention may be distributed amongst one or more networked computing devices which interact with computer system 100 via one or more data networks such as, for example, network 110. However, for ease of understanding, aspects of the invention have been embodied in a single computing device—computer system 100.

Computer system 100 includes processing system 102 which communicates with various input devices 104, output devices 106 and network 110. Input devices 104, two of which are shown, may include, for example, a keyboard, a mouse, a scanner, an imaging system (e.g., a camera, etc.) or the like. Similarly, output devices 106 (only one of which is illustrated) may include displays, information display unit printers and the like. Additionally, combination input/output (I/O) devices may also be in communication with processing system 102. Examples of conventional I/O devices include removable and fixed recordable media (e.g., floppy disk drives, tape drives, CD-ROM drives, DVD-RW drives, etc.), touch screen displays and the like.

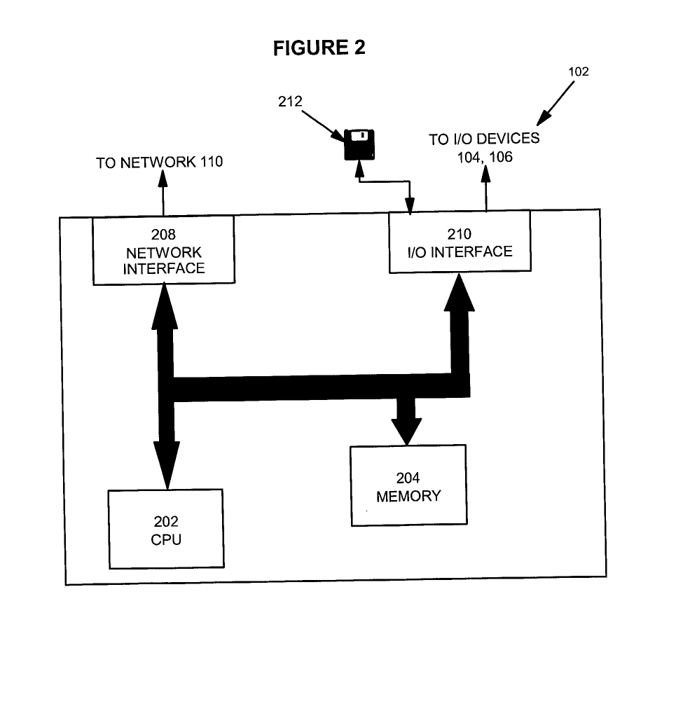

Exemplary processing system 102 is illustrated in greater detail in FIG. 2. As illustrated, processing system 102 includes several components—central processing unit (CPU) 202, memory 204, network interface (I/F) 208 and I/O I/F 210. Each component is in communication with the other components via a suitable communications bus 206 as required.

CPU 202 is a processing unit, such as an Intel Pentium™, IBM PowerPC™, Sun Microsystems UltraSparc™ processor or the like, suitable for the operations described herein. As will be appreciated by those of ordinary skill in the art, other embodiments of processing system 102 could use alternative CPUs and may include embodiments in which one or more CPUs are employed. CPU 202 may include various support circuits to enable communication between itself and the other components of processing system 102.

Memory 204 includes both volatile and persistent memory for the storage of: operational instructions for execution by CPU 202, data registers, application storage and the like. Memory 204 preferably includes a combination of random access memory (RAM), read only memory (ROM) and persistent memory such as that provided by a hard disk drive.

Network I/F 208 enables communication between computer system 100 and other network computing devices (not shown) via network 110. Network I/F 208 may be embodied in one or more conventional communication devices. Examples of a conventional communication device include an Ethernet card, a token ring card, a modem or the like. Network I/F 208 may also enable the retrieval or transmission of instructions for execution by CPU 202 from or to a remote storage media or device via network 110.

I/O I/F 210 enables communication between processing system 102 and the various I/O devices 104, 106. I/O I/F 210 may include, for example, a video card for interfacing with an external display such as output device 106. Additionally, I/O I/F 210 may enable communication between processing system 102 and a removable media 212. Although removable media 212 is illustrated as a conventional diskette other removable memory devices such as Zip™ drives, flash cards, CD-ROMs, static memory devices and the like may also be employed. Removable media 212 may be used to provide instructions for execution by CPU 202 or as a removable data storage device.

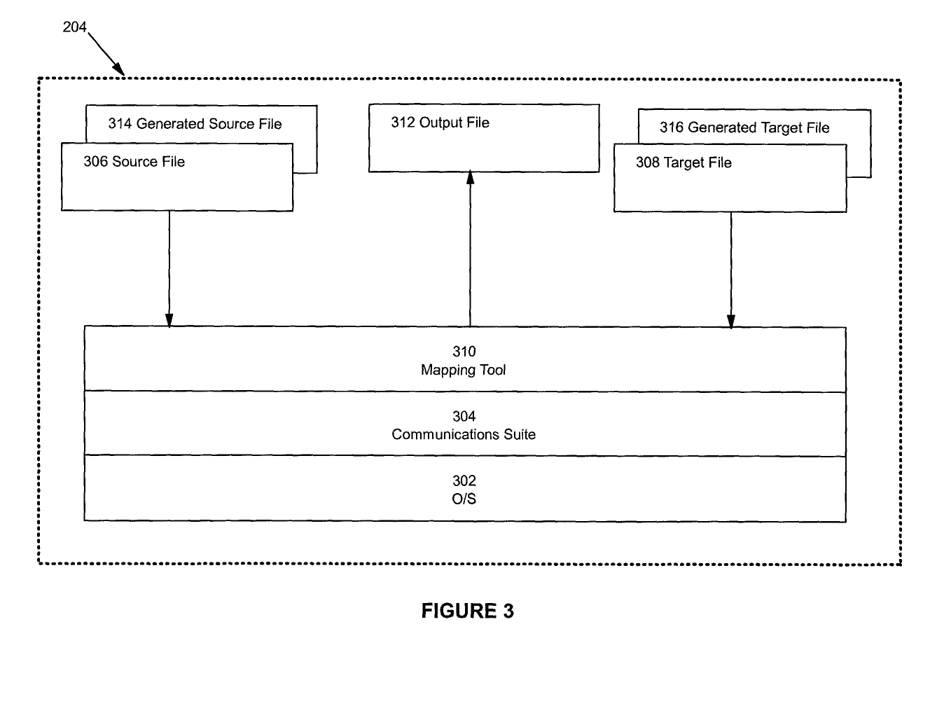

The computer instructions/applications and data stored in memory 204 and executed by CPU 202 (thus adapting the operation of computer system 100 as described herein) are illustrated in functional block form in FIG. 3. As will be appreciated by those of ordinary skill in the art, the delineation between aspects of the applications illustrated as functional blocks in FIG. 3 is somewhat arbitrary as the various operations attributed to a particular application as described herein may, in alternative embodiments, be subsumed by another application.

As illustrated, for exemplary purposes only, memory 202 stores operating system (OS) 302, communications suite 304, source file 306, target file 308, transformation tool 310, transformation output file 312.

OS 302 is an operating system suitable for operation with a selected CPU 202 and the operations described herein. Multitasking, multithreaded OSes such as, for example, IBM AIX™, Microsoft Windows NT™, Linux or the like, are expected in many embodiments to be preferred.

Communication suite 304 provides, through, interaction with OS 302 and network I/F 208 (FIG. 2), suitable communication protocols to enable communication with other networked computing devices via network 110 (FIG. 1). Communication suite 304 may include one or more of such protocols such as TCP/IP, ethernet, token ring and the like.

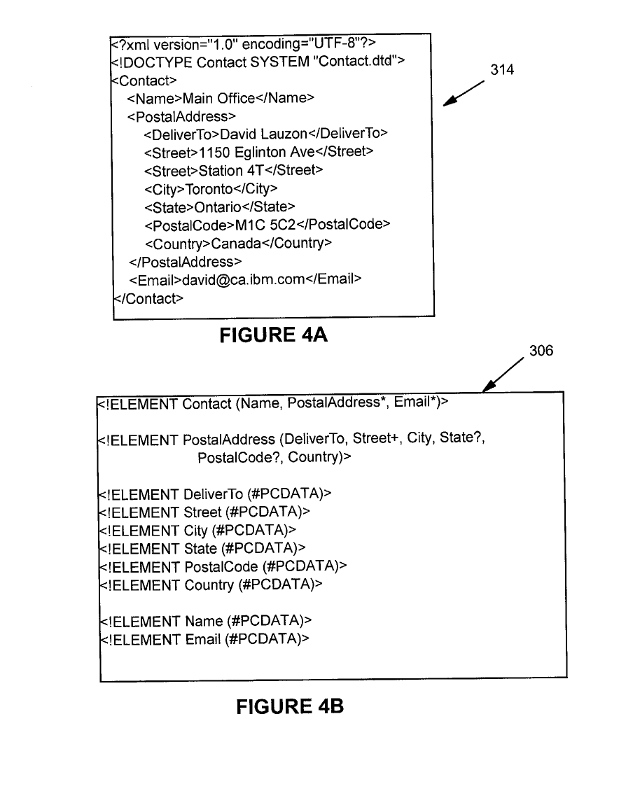

Source file 306, an example of which is illustrated in FIGS. 4A and 4B, may be in the form of a document type definition (DTD) file (as illustrated in FIG. 4B), an XML schema file (illustrated in FIG. 4A), XSD file, XML file, HTML file or the like. A DTD file is a file in a language that describes the contents of a document. A DTD file is typically used with XML. In fact, the DTD definitions may be embedded within an XML document, or in the exemplary embodiment, as a separate file—source file 306. An XML schema file defines the content used in a XML file. Unlike DTD files, XML schema files are written in XML syntax which, although more verbose than DTD files, can be created with any XML tool.

Source file 306 includes the basic structure for data which is to be mapped from the source file 306 to the data instance defined by target file 308. As will be described in greater detail below, the flexibility provided by transformation tool 310 enables a user to specify one or more source files 306 to generate an output file 312 for transforming instances of source file(s) 306 into instances of a single target file 308. Alternative embodiments may transform a single instance of source file 306 into multiple instances of target files 308. Similarly, a plurality (“n”) of source files 306 may be transformed into a plurality (“m”) of target files 308.

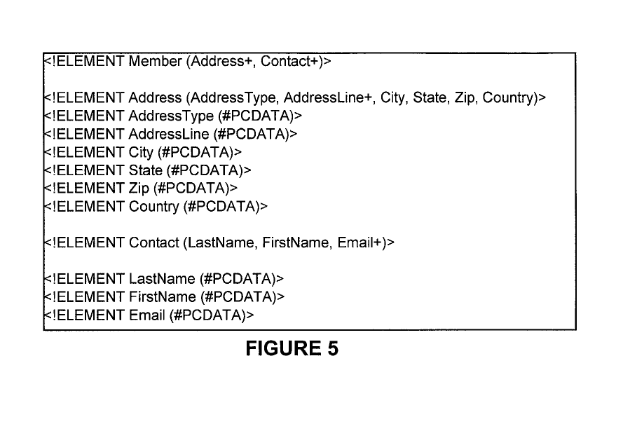

Target file 308, like source file 306 may be, for example, a DTD, an XML schema, XML file or the like. Additionally, target file 306 may be in a different format from the source file 306 such as, for example, HTML. An exemplary target file 308, a DTD file, is illustrated in FIG. 5.

In the present embodiment, and as will be described in greater detail below, the use of an embodiment of the invention will provide mapping between a source file 306 (in the form, for example, of an XML or HTML document) and a target file 308 (in the form, for example, of an XML or HTML document, which is not necessarily the same file type as the source—i.e., an XML source can be mapped to a HTML target and vice versa). However, and as indicated by exemplary source file 306 in FIG. 4B (which is in the form of a DTD file), the source file 306 and/or target file 308 do not necessarily define express sufficient particularities that are of interest to a user of configuration tool 310. For example, a DTD file, when viewed, does not easily express Xpath locations. Accordingly, to easily express the particularities of input data, a source file 306 which is in the form of a definition file (e.g., a DTD file), results in configuration tool 310 generating an instance conforming to the input definition (e.g., an XML instance file) which can more easily express the various particularities. The generated instance file which conforms to the definition file provided as source file 306 is referred to as generated source file 314. An exemplary generated source file 314 is illustrated in FIG. 4A.

FIG. 4A illustrates a generated source file 314 as an XML instance of a document definition provided by source file 308. Similarly, transformation tool 310 may also generate a generated target file 316 (which conforms to the specification described by target file 308) if the input target file 308 does not easily provide the particularities which may be required by a user of configuration tool 310.

If the generated file generated by transformation tool 310 is unsatisfactory to the user, the user may be prompted to provide a file which defines a more satisfactory data instance or modify the data instance generated.

If the input source and/or target files 306, 308 do provide sufficient detail (e.g., source and target files are XML files), embodiments of the present invention also require the corresponding DTD or schema files. As will be appreciated by those of ordinary skill in the art, transformation tool 310 could, in alternative embodiments, generate a corresponding DTD or schema file if the source and/or target file 306, 308 define an instance conforming to the source and/or target file (e.g., an XML file).

In any event, mapping by a user of the described embodiment of the present invention occurs between data instances. However, aspects of the present invention, as noted above, are equally applicable to input files which do not define a data instance.

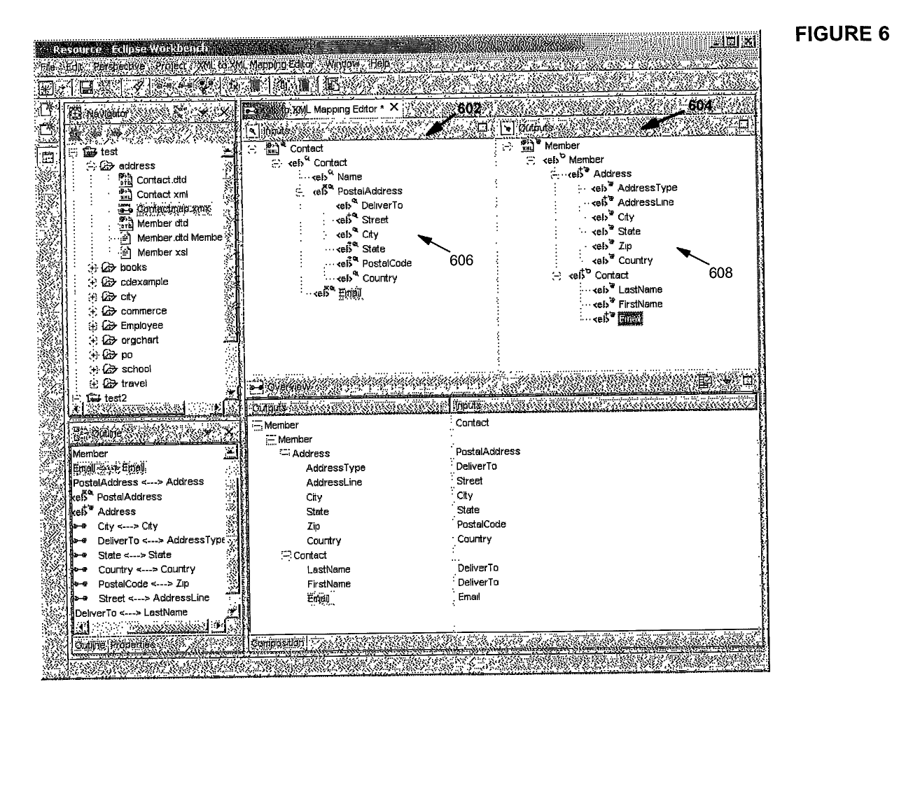

Transformation tool 310 is adapted to receive source and target files 306, 308 as input. Upon receipt of the input files (source, target files), transformation tool 310 provides to a user a visualization of the data instances described in the source and target files. Such a visualization for a simple source and target files 306, 308 is illustrated in FIG. 6. In the exemplary embodiment transformation tool 310 provides a graphical user interface (GUI) which enables a user of transformation tool 310 to visually inspect the source data instance (illustrated in FIG. 6 as source data instance 602) described by source file 306 and the target data instance (illustrated in FIG. 6 as target data instance 604) described by target file 308. As will be apparent to those of ordinary skill in the art, the exemplary embodiment provides that displayed elements 602 and 604 (FIG. 6) render an XML instance which conforms to source and target input files 306, 308. The rendering of an XML instance may be preferred as it provides context information such as the explicit parent/child relationships (including any nesting) which are not necessarily defined by a DTD or XML schema document. For example, a DTD file has only one explicit level of parent/child relationships (i.e., it has only one level of explicit nesting) in contrast to the explicit and multiple nesting description provided by an XML file. Additionally, a DTD file does not define a root element—in a DTD file any element can be a root element.

Transformation tool 310 operates to receive, from a user, mapping data indicating the transformation of one or more data elements or attributes from source data instance 602 (several elements/attributes 606 are illustrated in FIG. 6) to one or more data elements in target data instance 604 (several elements 608 are illustrated in FIG. 6). As will be explained in greater detail below with reference to numerous exemplary embodiments of the present invention, a single element or attribute in source data instance 306 maybe mapped to one or more elements in target data instance 308. Additionally, a plurality of elements or attributes in source data instance 306 may be mapped to a single element in target data instance 308. In further example and as will be apparent to those of ordinary skill in the art upon reviewing the entire specification, transformation tool 310 provides the ability to transform tag names and the form or format of the source data instance. Moreover, embodiments of transformation tool 310 provide for computational transformation (i.e., providing for some element manipulation) for transforming elements or attributes in source data instance 306 into a modified element target element 608 (i.e., a target element whose value is related to the value associated with the source element/attribute by some function).

Output file 312 provides a script (or source code) for constructing the data instance defined by the target file 308 from data in one or more source files 306. This construction may include filtering, combining, renaming, reordering or adding to the data instance defined by the source file(s) 306. Output file 312 is an expression of the semantics captured in the mapping of attributes and elements in the target file 308 from attributes and elements in one or more source files 306.

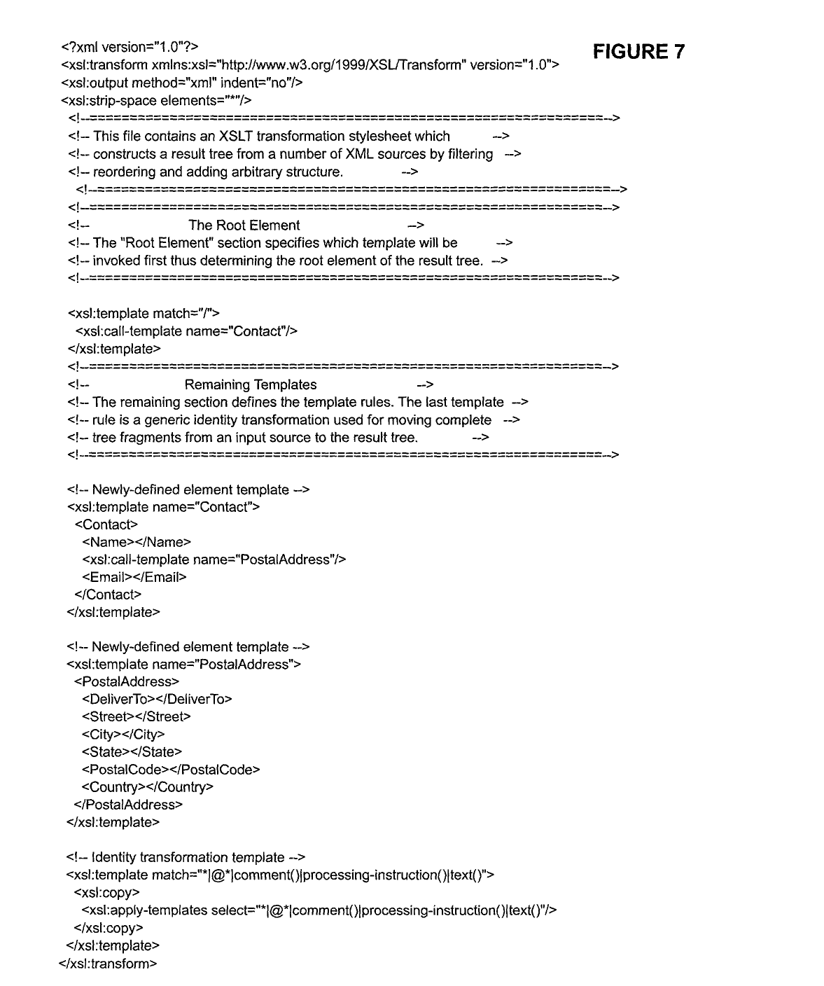

In the exemplary embodiment, output file 312 is an XLST text file containing a script which when processed by a suitable XLST processor (which, in the exemplary embodiment, conforms to the W3C XLST specifications) will transform instances described by source data instance 306 into instances of the data instance described by target file 308. In the exemplary embodiments described herein output file 312 comprises an XLST file, an example of which is illustrated in FIG. 7. However, other file types (such as, for example, Java code or the like) and, therefore, corresponding suitable processors, could alternatively be employed.

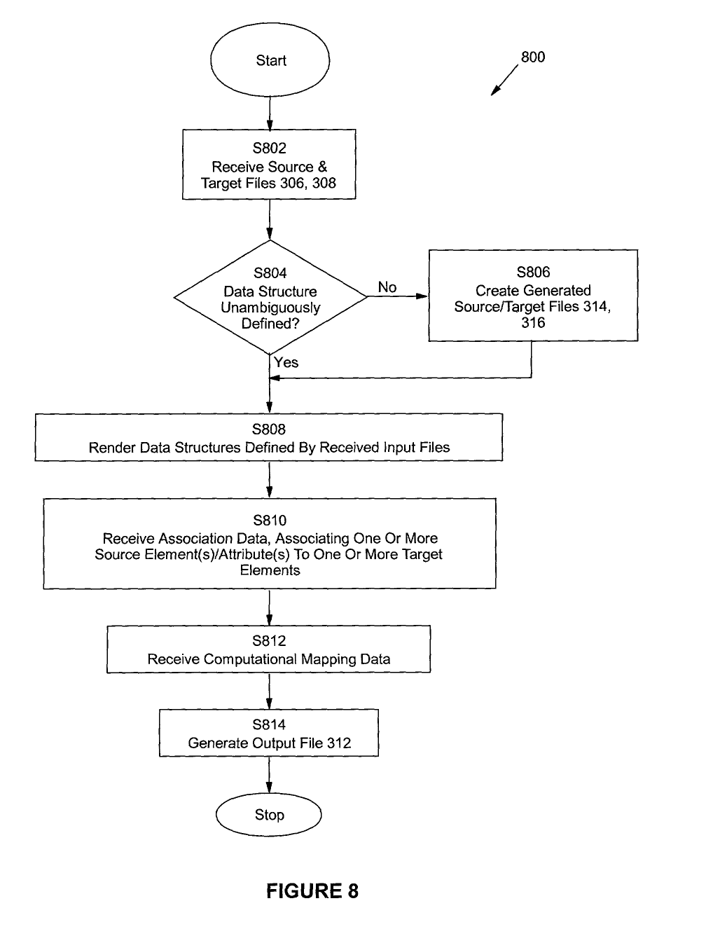

From the transformation or mapping data provided by the user, and in accordance with exemplary operations 800 (FIG. 8—described below in greater detail), transformation tool 310 generates output file 312.

From the foregoing, persons of ordinary skill in the art will appreciate that transformation tool 310 provides the following functionality: receipt of input files (e.g., source and target files 306, 308 and, if necessary generated source and target files 314, 316); rendering of a visual representation of the received input files; receipt of mapping data; and generating output file 312. As will be appreciated by those of ordinary skill in the art, to generate a rendering of the received input files, the received input files are processed so that the structure and particularities defined therein can be displayed. This processing may be provided using a conventional XML parser.

The operations of exemplary transformation tool 310 are best understood with reference to operations 800 (FIG. 8).

As indicated above, transformation tool 310 initially receives input files—source file 306 and target file 308 (S802). In the present exemplary embodiment, files 306, 308 are identified and provided to transformation tool 310 by a user graphically selecting the requisite files. Other manners of selecting/providing input files (e.g., command line interface, etc.) to transformation tool could alternatively be employed. Additionally, in the example described below, input source and target files 306, 308 are DTD files. (In an alternative embodiment source and target files 306, 308 could employ other file types). Consequently, these input files do not define a data instance. Accordingly, transformation tool 310, determining that the files input are do not provide the data instance detail required (S804), generates, based on the input files, generated source and target files 314, 316 which define a data instance (S806). If desired, a user can modify the generated files or be prompted to provide other suitable input files.

Once the data instances of the source and target have been recieved or generated (S802 and, optionally, S804), transformation tool 310 renders the data instance using a GUI (S808) from the input files 306, 308 (and, optionally, generated files 314, 316). An exemplary rendering is illustrated in FIG. 6.

A user is then enabled by the GUI portion of transformation tool 310 to map an element/attribute (hereinafter collectively a “node”) from the source data instance 602 (defined, in the exemplary embodiment by an XML instance file) to a node in the target data instance 604 (defined, in the exemplary embodiment by an XML instance file).

A user may map a node 606 from source data instance 602 to node 608 in target data instance 604 by selecting (using, for example, a mouse click) the desired portions of data instances 602, 604 and then performing a “mapping complete” operation (e.g., selecting a mapping icon, for example).

As indicated above, embodiments of the invention do not necessarily require a 1:1 mapping between a node 606 in the source and a node 608 in the target. Rather, many different types of mapping can be provided. Some example mappings are (with examples of when such a mapping may desirable):

(i) mapping a single node 606 to a single node 608 (this mapping provides, essentially, a copy or renaming of a node in source data instance 602 to a node in target data instance 604; (this type of mapping may be useful when, for example, a “State” element in the source data instance maps to a “Province” data instance in the target data instance 604);

(ii) mapping multiple nodes 606 to a single node 608 (this mapping provides, essentially, an N:1 relationship between source nodes 606 and a target node 608; such mapping may use, when the output file is an XLST file, XPath expressions, for example, which provide simple data manipulation functions (e.g., string manipulation, Boolean operations, mathematical operations, etc.); (for example, a “DeliverTo” element 608 in the target data instance may be mapped from a concatenation of “FirstName” and “LastName” nodes 606 in the source data instance);

(iii) mapping a portions of a node 606 to multiple nodes 608 (this mapping provides, essentially, a 1:N relationship between a source node 606 and target nodes 608; such mapping may use similar functions or expressions for the N:1 mapping (described above) (for example, portions of a “StreetAddress” element in the source data instance, which includes a numerical portion and street name, may be mapped to a “StreetNumber” and a “StreetName” element in the target data instance);

(iv) mapping a function of a node(s) 606 in source data instance 602 to a node 608 in target data instance 604 (this mapping provides users an ability to populate a target element derived from a source node; the function which operates on the source node may be, for example, provided by an internal function or external (i.e., non-XML) code, such as a JavaBean or the like; (for example, an “ISBN” node, which uniquely identifies a book, may be used by a function to retrieve a book's unit price from a database which can then be used to populate a “BookUnitPrice” element in the target data instance);

(v) mapping between a source file type (e.g., XML) and a target file type (e.g., HTML); such a mapping may also be used to group data (i.e., format the data into a table or other visual construct) (for example, XML instances describing books may be mapped to an HTML target data instance which presents the data to be in table form);

(vi) converting between a view or ordering defined by the source data instance 602 to an alternate view or ordering defined by the target data instance 604 (for example, data describing a school may be defined and ordered in the source data instance by student but be ordered by another data element (e.g., grade, courses, location of residence, etc.) in the target data instance); and

(vii) mapping between a node(s) 606 (as described above) from multiple source data instances 602 (defined by multiple source files and, optionally, generated source files) to a target data instance 604 (for example, in the travel industry it is common to in order to generate a traveler's itinerary data from multiple sources (e.g., an airline database, a hotel database, a car rental database, etc.) is required; accordingly, in this example, several source data instances from the various travel related databases can be mapped to a single itinerary/target data instance).

As will be appreciated by those of ordinary skill in the art, the above enumeration of mappings is not exhaustive and other mappings and functions applied thereto are possible and within the sphere and scope of the present invention. As will be further appreciated by those of ordinary skill in the art, not all of the nodes in source data instance 602 need to, or will be, mapped to nodes forming part of target data instance 604. Similarly, nodes forming part of target data instance 604 need not be associated with a node forming part of source data instance 602.

The mapping data described in the enumerated items above include references to source and target data instance nodes 606, 608 and, optionally, functions which operate on the source data instance elements. In the exemplary embodiment this data is provided to transformation tool 310 in two steps—S810 and S812. In the first step, transformation tool 310 receives data describing the association between a source node(s) and a target node(s) (S810). Thereafter, a user may further define the association by selecting a function (e.g., an Xpath operation, invoking a method in a JavaBean, etc.) to operate on the source node (S812). Together the association data and the optional function performed to further define the association represent mapping data. As will be appreciated by those of ordinary skill in the art, operations S810 and S812 could be reversed in order or even combined into a single operation.

Continuing with reference to FIG. 8 and operations 800, after the user has provided the requisite association data (S810) and any functional/operational data (S812), transformation tool 310 uses this information to generate output file 312 which, in the exemplary embodiment is a script in the XLST language (S814).

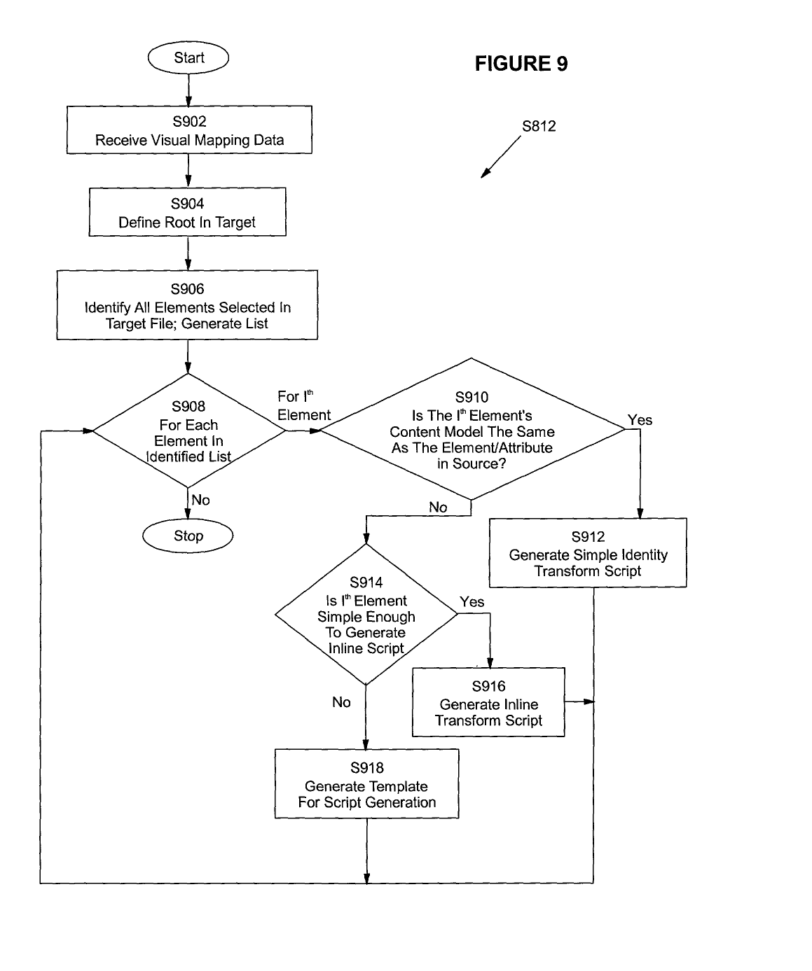

Operation S814 is further explained with reference to the flowchart illustrated in FIG. 9. Hereinafter, the embodiment described assumes that the output file 312 is an XLST file. However, the operations described for generating an output file which can be used to transform instances of data which conform to the source data instance to instances of data which conform to the target data instance are applicable to other languages with changes made to conform with the syntax of these other languages.

Upon receipt of the mapping data (S902—which is the data from the user in S810), transformation tool 310 will define a root element template in the output file 312 based on the user selected mappings to elements in target data instance 604 (S904). In the exemplary embodiment transformation tool 310 defines a root element in two separate manners. If target file 308 is a DTD or XML schema file, the user is prompted to identify the root element. If, however, target file 308 is an XML file, for example, then transformation tool 310 is able to easily determine the root element in target file 308. As a result of operation S904, transformation tool 310 has defined the root element template—the starting point for the desired transformation.

After defining a root element template, the elements in the target data instance 604 are identified to ensure that the elements identified are unique and the definitions for these identified elements are available. A list of these identified target elements is generated by transformation tool (S906). By identifying the elements using the DTD rather than the XML document it is ensured that the elements are uniquely defined. For each element in the identified element list (S908) portions of operations S910-S918 are performed.

Operations S910-S918 generate the XLST text which, when processed and applied to instances of data conforming to the source data definition (e.g., a DTD or XSD file), will output data which conforms to the target data definition. Reference in the description of operations S910-S918 will be made to the “i^{th}” element—simply one element which forms part of the identified element list generated in S906.

If the i^{th} element's content model (described below) is identical to the content model of the associated source node (S910), then a simple identity script is generated in output file 312 (S912). If the name, content model and attributes of an node are unchanged from the source to the target, then no specific template for this transformation is generated. Rather, an identity script is employed.

An identity script, when processed, does not alter the source node when it is transformed into the target node. Rather and essentially, the source node is transcribed into its associated target node.

A content model describes the content structure of child elements in an XML document. In the exemplary embodiment the i^{th} element's content model would describe content structure of the i^{th} element in target data instance 604. An element may have an empty content model but still have attributes defined thereon. The identity transformation is used for moving a complete portion of a data instance from the source data instance (i.e., a tree fragment) to the data instance or tree defined by the target file 308. The tree fragment may include nodes such as elements, attributes, comments, processing-instructions and text. The identity transformation template gets instantiated whenever there is no specific applicable template rule for a given node.

If, however, the i^{th} element's name, content model or attributes is not the same as in the source (S910), then operation S914 is performed. If the i^{th} element is simple (i.e., use of a template would not provide any enhanced ease of understanding for a user examining output file 312) (S914), a simple in-line or a literal result script is generated in output file 312 (S916). For ease of understanding, a template or template body in XLST is analogous to a block or routine in a block-structured programming language such as, for example, C, C++ or Java. Accordingly, persons of ordinary skill in the art will appreciate from this analogy that embodiments of the present invention could equally generate, instead of an XLST output file, a corresponding structured programming language source code file which could be compiled/interpreted to provide the transformation from source data instance to target data instance desired by the user of transformation tool 310.

If, however, transformation tool 310 determines that the i^{th} element is not simple (S914), a XLST template will be generated for this i^{th} element (S918). Operations S908-S918 will be repeated for the remaining elements in the list generated in S906.

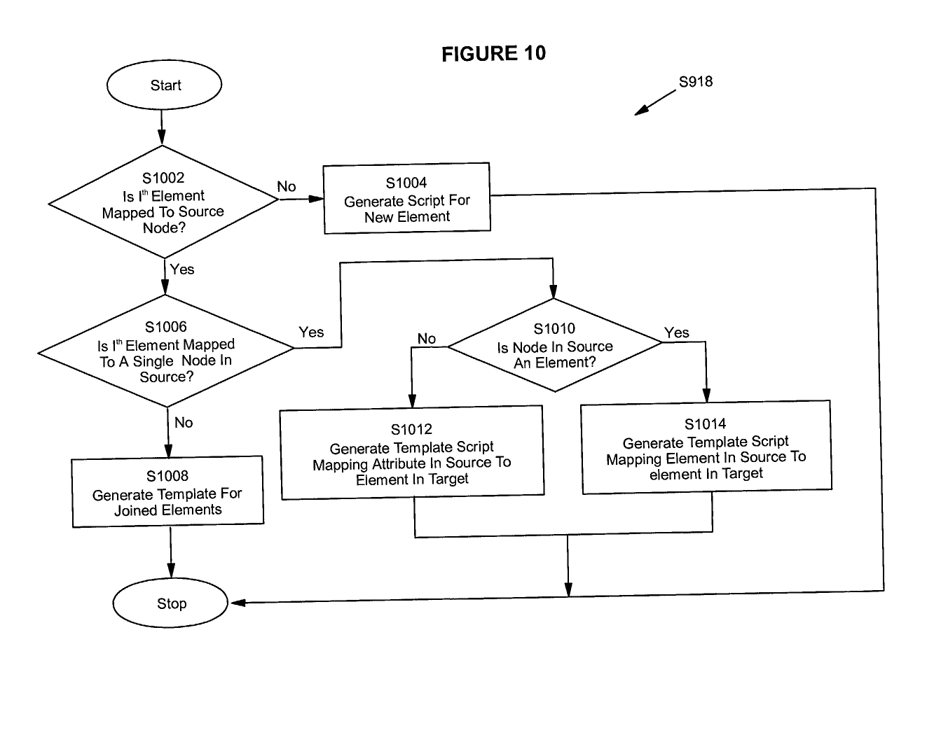

The generation of a template (S918) is better understood with reference to the flow chart illustrated in FIG. 10.

In generating a template for the i^{th} element transformation tool 310 determines whether the i^{th} element in the list generated in S906 (and, thus, an element in target data instance 604) is mapped to (i.e., associated with) a corresponding node in source data instance 602 (S1002). If there is no such association, a script is generated in output file 312 in the template created for the i^{th} element which identifies the i^{th} element as a “new” (i.e., it is not associated with a source node) element (as compared to the source data instance 602) (S 1004). A “new” element may still have a function or method associated with it. Also, a “new” element, may also be associated with a default value specified in the target file 308.

If, however, the i^{th} element is not “new” (i.e., the i^{th} element is mapped from a node(s) in the source data instance 602) (S1002), transformation tool 310 determines whether the i^{th} element maps from a single node or from multiple nodes (S1006). If transformation tool 310 determines that the i^{th} element is mapped from a single node operation S1010 is performed. Otherwise, transformation tool 310 generates script in the template which reflects the combination of the two or more nodes (S1008).

Combining two or more nodes is similar to a table join in a relational database. When two or more nodes are combined, the Cartesian product of the nodes is produced by default (i.e., all possible combinations of the nodes are processed). When a condition is specified, a particular combination is produced only if the condition, associated with the combination, holds. This is accomplished in the template by generating an “xsl:for-each” loop and a corresponding local variable for each source node participating in the mapping. The local variable specifies the current context within the “xsl:for-each” loop. The condition is then generated at the beginning of the inner most loop.

After generating the script which combines multiple source nodes has been inserted into output file 312, operation S918 (FIG. 10, FIG. 9) has completed and, as described above, the remaining elements are processed by similar operations.

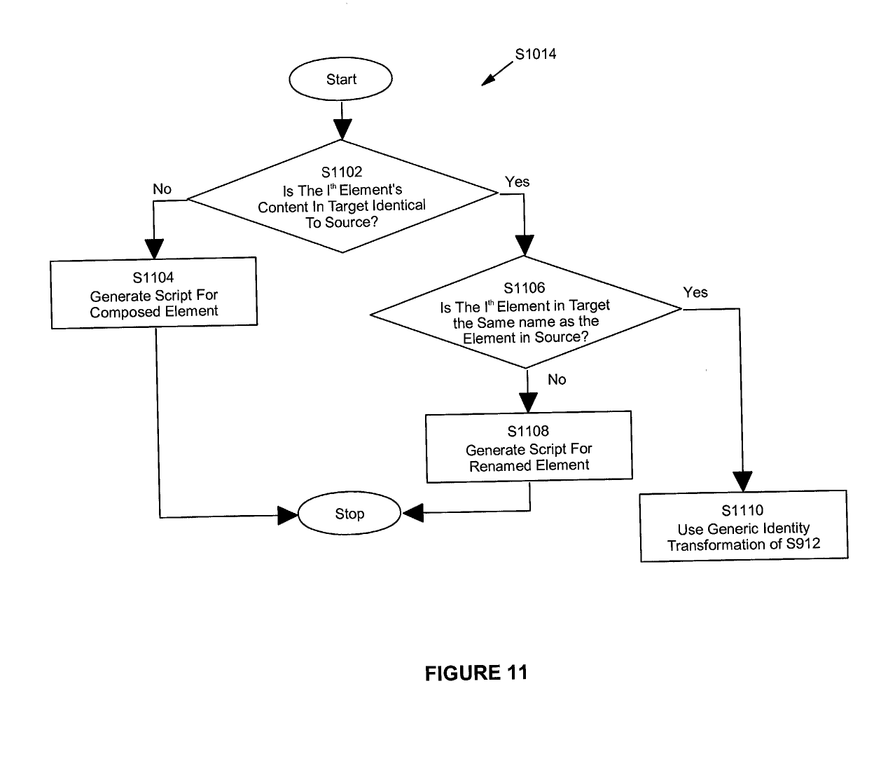

If it is determined that the mapping to the i^{th} element is from a single node (S1006) operation S1010 is performed. In operation S1010 transformation tool 310 determines if the i^{th} element is mapped from an element or an attribute. If the mapping is from an attribute, then a simple script performing this mapping is generated in the body of the template (S1012). Otherwise, operation S1014 is performed to generate a script which maps a source element to the i^{th} target element. Operation S1014 is best understood with reference to the flowchart of FIG. 11.

Transformation tool 310, upon determining that the i^{th} element in the target data instance 604 is mapped from a element (S1012), determines if the content model associated with the i^{th} element is identical to the mapped from source element (S1102). If the two content models for the two elements are identical, then mapping from the source element to the i^{th} target element may be effectively a renaming of the source element (S1106). If the mapping is effectively a renaming of an element, a script is generated to reflect this situation in the template being generated in output file 312 (S1108). If the mapping does not require a renaming (i.e., the mapping is effectively a transcription or transposition) then the identity transformation script of S912 (FIG. 9) is used to generate the necessary transformation script for output file 312 (S1110).

In the other case (the content model for the i^{th} target element and the source element are not identical) then a script or template is generated to compose the i^{th} element from the mapped from source element (S1104).

Generating a template for a composed element can be broken down into three operations. In the first operation, local variables are generated for any procedure or function calls (e.g., Java method calls) within the template so that the return values can be reused locally. In the second operation, the attributes for the composed element are generated explicitly or, if the elements are simply copied from the input, generically. In the last operation, the content model for the composed element is generated. The content model is composed of particles which can be of type character data, element reference, choice or sequence or the like. Generating a content particle takes into consideration the occurrence indicator of the particle itself, as well as, that of the immediate outer group (sequence or choice). It is important to note that, in the exemplary embodiment, the code created to generate an element definition is based on the content model found in the DTD.

As will be appreciated from the foregoing description, and specifically the description of operations 800 (FIG. 8) and the sub-components thereof (illustrated in flowcharts in FIGS. 9, 10 and 11), the exemplary embodiment of the present invention will generate a script which, when processed or executed, can transform an incoming data stream which conforms with the data instance defined by the source inputs (source file 306 and, optionally, generated source file 314) into the data instance defined by the target inputs (target file 308 and, optionally, generated target file 316). By processing this resulting output file 312 (e.g., an XLST file) an input data stream describing various data elements can be easily and automatically transformed into conformance with the target data instance and then be used for a variety purposes.

As a consequence of the foregoing, data generated in, for example, XML describing data in a first vocabulary can be received, transformed into a second vocabulary and used efficiently and effectively by the recipient (e.g., a person, process, application, etc.). Moreover, the present invention does not require a user to have a detailed understanding of the input or output files or their associated syntax. Rather, the user need only have an understanding of the data described by the rendering provided by transformation tool 310. In a further advantage, the user of embodiments of the present invention are removed from the complexity of generating the complex scripting necessary to perform the desired transformation.

As will be appreciated by those of ordinary skill in the art, many different and alternative embodiments of the present invention which fall within the sphere and scope of the claims appended hereto are possible.

For example, it was indicated above that input source and target files 306, 308 could conform to different formats (e.g., DTD, XSD, XML, etc.). Accordingly, in one embodiment of the present invention transformation tool 310 incorporates (or, alternatively, accesses) a tool to provide a layer of abstraction between the input files and operations 800 performed by transformation tool 310. While such an abstraction layer would not impact the user, such a layer of abstraction would enable transformation tool 310 and operations 800 to be performed without any reference to the underlying format of the input files. Such an abstraction layer may be implemented by using portions of the Document Object Model (DOM) Level 3, which is available from the w3c, having its primary web site at http://w3c.org. The contents of the DOM Level 3 specification, including the Content Models and Load and Save Specification, is hereby incorporated herein by reference.

In a further alternative embodiment of the present invention, the use of templates in the XLST language (or their structured counterparts in structured languages) could be eliminated and replaced with simple in-line type scripting. However, it is believed that such an embodiment, while useful, would not provide an output file which is as easily understood as the template structure described above. However, use of a template script for an element definition may result in some loss in the flexibility provided by transformation tool 310. For example, if an element occurs in more than one place in a target document and it is desired to map different source elements/attributes for each occurrence in the target document (or it is desired to apply different functions for each occurrence in the target document) use of a template script may not provide this functionality. In these types of situations in-line code generation may be preferred as it provides the desired flexibility.

In the exemplary embodiment described herein, all aspects of the present invention are described as residing on computer system 100. In an alternative embodiment, and as alluded to above, portions of the present invention could be distributed amongst a plurality of computers interconnected by a persistent or transient network connection. For example, input files could reside on a file server and transformation tool 310 could reside on an application server or local computer. Additionally, transformation tool 310 which, as described above, consists of several components, could itself be similarly distributed amongst a plurality of computers.

As will be appreciated by those of ordinary skill in the art, the delineation between the various components and files is somewhat arbitrary and could be altered without departing from the spirit and scope of the present invention and falling within the scope of the claims appended hereto.

While one (or more) embodiment(s) of this invention has been illustrated in the accompanying drawings and described above, it will be evident to those skilled in the art that changes and modifications may be made therein without departing from the essence of this invention. All such modifications or variations are believed to be within the sphere and scope of the invention as defined by the claims appended hereto. Other modifications will be apparent to those skilled in the art and, therefore, the invention is defined in the claims.

What is claimed is:

1. A method for transforming data conforming to a source data instance to data conforming to at least a portion of a target data instance, said method comprising:
receiving mapping data, said mapping data mapping at least a portion of said source data instance to at least a portion of said target data instance;
responsive to said mapping data received, generating a data instance transformation script whereby processing said script transforms data conforming to said source data instance to data conforming said target data instance; and
wherein generating a data instance transformation script comprises:
identifying each element in said target data instance; and
for an element identified:
generating an element transform script transforming data conforming to said source data instance to said element identified, wherein said element transform script corresponds to a portion of said mapping data.

2. The method of claim 1 wherein said generating said element transform script further comprises:
if said element identified is not mapped to a portion of said source data instance,
generating a script for a new element.

3. The method of claim 2 wherein said generating said element transform script further comprises:
if said element identified is mapped to a portion of said source data instance:
if the content model of said element identified is the same as the content model of a portion of said source data instance, generating an identity transformation script transforming data conforming to said portion of said source data instance to data conforming said element identified.

4. The method of claim 4 wherein said generating said element transform script further comprises:
if said element identified is mapped to a portion of said source data instance:
if the content model of said element identified is not the same as the content model of an element of said source data instance, generating a template for transforming said portion of said source data instance to said element identified.

5. The method of claim 1 wherein said data instance transformation script comprises one of: a script; and source code.

6. The method of claim 1 further comprising, prior to said mapping, receiving input data, said input data describing said source data instance and said target data instance.

7. The method of claim 6 further comprising, prior to said mapping, rendering said input data.

8. The method of claim 7 wherein said mapping data received comprises data generated through user interaction with said rendered input data.

9. The method of claim 8 wherein:
prior to said rendering, determining whether said input data explicitly defines said source data instance and said target data instance; and
and if said input data explicitly defines said source data instance and said target data instance, performing said generating of said data instance transformation script; and if said input data does not explicitly define said source data instance and said target data instance, generating an explicit source data instance and/or target data instance conforming to said input data.

10. The method of claims 1 wherein said mapping data comprises at least one of association data and operation data; said association data comprising data describing association between one or more portions of said source data instance and one or more portions of said target data instance; said operation data comprising data describing operations performed to generate data to be associated with one or more portions of said target data instance.

11. The method of claim 10 wherein said operations performed comprise operations performed on one more portions of said source data instance.

12. The method of claim 10 wherein said operations performed comprise retrieving data from a database responsive to data from one or more portions of said source data instance.

13. The method of claim 1 wherein said source data instance is described by source markup language data and said target data instance is described by target markup language data.

14. The method of claim 13 wherein said source markup language data comprises one of: an XML file, an HTML file and an SGML file; and wherein said target markup language data comprises one of: an XML file, an HTML file and an SGML file.

15. The method of claim 13 wherein said source data instance is further described by source definition data and target data instance is described by target definition data.

16. The method of claim 15 wherein said source definition data comprises one of: a DTD file; and an XSD file; and wherein said target definition data comprises one of: a DTD file; and an XSD file.

17. A computer readable medium storing data and instructions, said data and instructions, when processed by a computer system adapts said computer system to:
receive mapping data, said mapping data mapping at least a portion of a source data instance to at least a portion of a target data instance;
responsive to said mapping data received, generate a data instance transformation script whereby processing said script transforms data conforming to said source data instance to data conforming said target data instance; and
wherein said data and instructions adapting said computer system to generate said data instance transformation script generated comprises data and instructions adapting said computer system to:
identify each element in said target data instance; and
for an element identified:
generate an element transform script transforming data conforming to said source data instance to said element identified, wherein said element transform script corresponds to a portion of said mapping data.

18. The computer readable medium of claim 17 wherein said data and instructions adapting said computer system to generate said data instance transformation script further adapts said computer system to:
if said element identified is not mapped to a portion of said source data instance, generate a script for a new element.

19. The computer readable medium of claim 18 wherein said data and instructions adapting said computer system to generate said element transform script further adapts said computer system to:
if said element identified is mapped to a portion of said source data instance:
if the content model of said element identified is the same as the content model of a portion of said source data instance, generate an identity transformation script transforming data conforming to said portion of said source data instance to data conforming said element identified.

20. The computer readable medium of claim 19 wherein said data and instructions adapting said computer system to generate said element transform script further adapts said computer system to:
if said element identified is mapped to a portion of said source data instance:
if the content model of said element identified is not the same as the content model of an element of said source data instance, generate a template for transforming said portion of said source data instance to said element identified.

21. The computer readable medium of claim 17 wherein said data instance transformation script comprises one of: a script; and source code.

22. The computer readable medium of claim 17 wherein said data and instructions further adapt said computer system to: prior to said mapping, receive input data, said input data describing said source data instance and said target data instance.

23. The computer readable medium of claim 22 wherein said data and instructions further adapt said computer system to: prior to said mapping, render said input data.

24. The computer readable medium of claim 23 wherein said mapping data received comprises data generated through user interaction with said rendered input data.

25. The computer readable medium of claim 24 wherein said data and instructions further adapt said computer system to:
prior to said rendering, determine whether said input data explicitly defines said source data instance and said target data instance; and
and if said input data explicitly defines said source data instance and said target data instance, performing said generating of said data instance transformation script;
and if said input data does not explicitly define said source data instance and said target data instance, generate an explicit source data instance and/or target data instance conforming to said input data.

26. The computer readable medium of claims 17 wherein said mapping data comprises at least one of association data and operation data; said association data comprising data describing association between one or more portions of said source data instance and one or more portions of said target data instance; said operation data comprising data describing operations performed to generate data to be associated with one or more portions of said target data instance.

27. The computer readable medium of claim 26 wherein said operations performed comprise operations performed on one more portions of said source data instance.

28. The computer readable medium of claim 26 wherein said operations performed comprise retrieving data from a database responsive to data from one or more portions of said source data instance.

29. The computer readable medium of claims 17 wherein said source data instance is described by source markup language data and said target data instance is described by target markup language data.

30. The computer readable medium of claim 29 wherein said source markup language data comprises one of: an XML file, an HTML file and an SGML file; and wherein said target markup language data comprises one of: an XML file, an HTML file and an SGML file.

31. The computer readable medium of claim 29 wherein said source data instance is further described by source definition data and target data instance is described by target definition data.

32. The computer readable medium of claim 31 wherein said source definition data comprises one of: a DTD file; and an XSD file; and wherein said target definition data comprises one of: a DTD file; and an XSD file.

33. An apparatus for transforming data conforming to a source data instance to data conforming to at least a portion of a target data instance, said apparatus comprising:
a means for mapping data, said mapping data mapping at least a portion of said source data instance to at least a portion of said target data instance;
responsive to said mapping data received, a means for generating a data instance transformation script whereby processing said script transforms data conforming to said source data instance to data conforming said target data instance; and
wherein said generating of said data instance transformation script generated comprises:
a means for identifying each element in said target data instance; and
for an element identified:
a means for generating an element transform script transforming data conforming to said source data instance to said element identified, wherein said element transform script corresponds to a portion of said mapping data.

34. The apparatus of claim 33 wherein said means for generating said data instance transformation script comprises:
if said element identified is not mapped to a portion of said source data instance, a means for generating a script for a new element.

35. The apparatus of claim 34 wherein said means for generating said element transform script comprises:
if said element identified is mapped to a portion of said source data instance:
if the content model of said element identified is the same as the content model of a portion of said source data instance, a means for generating an identity transformation script transforming data conforming to said portion of said source data instance to data conforming said element identified.

36. The apparatus of claim 35 wherein said means for generating said element transform script further comprises:
if said element identified is mapped to a portion of said source data instance:
if the content model of said element identified is not the same as the content model of an element of said source data instance, a means for generating a template for transforming said portion of said source data instance to said element identified.

37. The apparatus of claim 33 wherein said data instance transformation script comprises one of: a script; and source code.

38. The apparatus of claim 33 further comprising: prior to said mapping, a means for receiving input data, said input data describing said source data instance and said target data instance.

39. The apparatus of claim 38 further comprising: prior to said mapping, a means for rendering said input data.

40. The apparatus of claim 39 wherein said mapping data received comprises data generated through user interaction with said rendered input data.

41. The apparatus of claim 40 further comprising:
prior to said rendering, a means for determining whether said input data explicitly defines said source data instance and said target data instance; and
and if said input data explicitly defines said source data instance and said target data instance, generating said data instance transformation script;
and if said input data does not explicitly define said source data instance and said target data instance, generating an explicit source data instance and/or target data instance conforming to said input data.

42. The apparatus of claim 33 wherein said mapping data comprises at least one of association data and operation data; said association data comprising data describing association between one or more portions of said source data instance and one or more portions of said target data instance; said operation data comprising data describing operations performed to generate data to be associated with one or more portions of said target data instance.

43. The apparatus of claim 42 wherein said operations performed comprise operations performed on one more portions of said source data instance.

44. The apparatus of claim 42 wherein said operations performed comprise retrieving data from a database responsive to data from one or more portions of said source data instance.

45. The apparatus of claim 33 wherein said source data instance is described by source markup language data and said target data instance is described by target markup language data.

46. The apparatus of claim 45 wherein said source markup language data comprises one of: an XML file, an HTML file and an SGML file; and wherein said target markup language data comprises one of: an XML file, an HTML file and an SGML file.

47. The apparatus of claim 45 wherein said source data instance is further described by source definition data and target data instance is described by target definition data.

48. The apparatus of claim 47 wherein said source definition data comprises one of: a DTD file; and an XSD file; and wherein said target definition data comprises one of: a DTD file; and an XSD file.

49. The apparatus of claim 33 wherein said apparatus comprises a computer system.
